(19) United States
(12) Patent Application Publication
(10) Pub. No.: US 2021/0203825 A1
(43) Pub. Date: Jul. 1, 2021

(54) TECHNIQUES FOR CORRECTING VIDEO ROLLING SHUTTER JELLO EFFECT FOR OPEN LOOP VOICE-COIL MOTOR CAMERAS

(71) Applicant: QUALCOMM Incorporated, San Diego, CA (US)

(72) Inventors: Yihe YAO, San Diego, CA (US); Kai Tung Teng, New Taipei City (TW); Lei Ma, San Diego, CA (US)

(21) Appl. No.: 16/728,583

(22) Filed: Dec. 27, 2019

(51) Int. Cl. H04N 5/232

(52) U.S. Cl. CPC H04N 5/2328; H04N 5/23254; H04N 5/23258

(57) ABSTRACT

Methods, systems, and devices for techniques for correcting video rolling shutter jello effect for open loop voice-coil motor cameras are described. A device may capture an image using an open loop voice-coil motor camera including a lens barrel assembly, a base mount, and a brake caliper. The base mount associated with the lens barrel assembly may include the brake caliper. The device may determine a vibration frequency parameter associated with a gyroscope sensor exceeds a threshold. Based on the vibration frequency parameter exceeding the threshold, the device may measure an image sharpness parameter associated with the image. In some aspects, the device may configure engagement of the brake caliper with the lens barrel assembly based on the image sharpness parameter.

### BACKGROUND

The following relates generally to image processing, and more specifically to techniques for correcting video rolling shutter jello effect for open loop voice-coil motor cameras.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

Some devices, such as smartphones, tablets, home security systems, automobiles, drones, aircrafts, etc. may be deployed to collect various types of information, such as visual information. These devices may be configured with optical instruments that are configured to capture the visual information in the form of images or video, which may be stored locally or remotely. In some examples, an optical instrument may be an image sensor configured to capture visual information using photosensitive elements, which may be tunable for sensitivity to a visible spectrum of electromagnetic radiation. In some cases, to support in capturing the visual information, these devices may be configured with light sources that may illuminate target objects or target areas in a physical environment.

### SUMMARY

The described techniques generally relate to improved methods, systems, devices, and apparatuses that support correction of video rolling shutter jello effect for open loop voice-coil motor cameras. A camera module (e.g., an open loop voice-coil motor camera module without an optical image stabilization actuator) may be equipped with a programmable brake caliper for improved rolling shutter correction. For example, the brake caliper may be physically located between a movable lens barrel assembly and a base mount (e.g., a lens barrel mount) of the camera module. The brake caliper may be mounted or connected to the base mount such that, upon engagement of the brake caliper, the lens barrel may be secured or fixed in position relative to the base mount (e.g., such that engagement of the brake caliper may lock focus settings).

The camera module may engage or disengage the brake caliper based on motion detected by a gyroscope sensor coupled to the base mount. When high frequency motion (e.g., strong vibration) is detected by a gyroscope sensor (e.g., via angular rotation measurements), the camera module may determine whether or not to engage (e.g., firmly connect) the brake caliper to the lens barrel assembly (e.g., to lock focus settings). For example, if high frequency motion is detected by the gyroscope sensor and the camera module determines image sharpness is still above a threshold, the camera module may firmly connect the brake caliper to the lens barrel assembly and base mount. As such, the brake caliper may be engaged to temporarily lock focus settings, when high frequency motion is detected, in cases where the image is sharp (e.g., versus otherwise refocusing the lens barrel assembly upon detection of high frequency motion). In some cases, the camera module may perform a refocus operation (e.g., if the image is blurry, if a scene change is detected, if a change in the target scene or target object is triggered, after an elapsed time period, etc.), and the camera module may release the brake caliper, allowing the lens barrel to move for refocus.

A method of image capturing at a device is described. The method may include capturing an image using an open loop voice-coil motor camera including a lens barrel assembly, a base mount, and a brake caliper, where the base mount associated with the lens barrel assembly includes the brake caliper. The method may further include determining a vibration frequency parameter associated with a gyroscope sensor exceeds a threshold, measuring an image sharpness parameter associated with the image based on the vibration frequency parameter exceeding the threshold, and configuring engagement of the brake caliper with the lens barrel assembly based on the image sharpness parameter.

An apparatus for image capturing at a device is described. The apparatus may include a processor, memory coupled with the processor, and instructions stored in the memory. The instructions may be executable by the processor to cause the apparatus to capture an image using an open loop voice-coil motor camera including a lens barrel assembly, a base mount, and a brake caliper, where the base mount associated with the lens barrel assembly includes the brake caliper. The instructions may be executable by the processor to further cause the apparatus to determine a vibration frequency parameter associated with a gyroscope sensor exceeds a threshold, measure an image sharpness parameter associated with the image based on the vibration frequency parameter exceeding the threshold, and configure engagement of the brake caliper with the lens barrel assembly based on the image sharpness parameter.

Another apparatus for image capturing at a device is described. The apparatus may include means for capturing an image using an open loop voice-coil motor camera including a lens barrel assembly, a base mount, and a brake caliper, where the base mount associated with the lens barrel assembly includes the brake caliper. The apparatus may further include means for determining a vibration frequency parameter associated with a gyroscope sensor exceeds a threshold, measuring an image sharpness parameter associated with the image based on the vibration frequency parameter exceeding the threshold, and configuring engagement of the brake caliper with the lens barrel assembly based on the image sharpness parameter.

A non-transitory computer-readable medium storing code for image capturing at a device is described. The code may include instructions executable by a processor to capture an image using an open loop voice-coil motor camera including a lens barrel assembly, a base mount, and a brake caliper, where the base mount associated with the lens barrel assembly includes the brake caliper. The code may include instructions further executable by a processor to determine a vibration frequency parameter associated with a gyroscope sensor exceeds a threshold, measure an image sharpness parameter associated with the image based on the vibration frequency parameter exceeding the threshold, and configure engagement of the brake caliper with the lens barrel assembly based on the image sharpness parameter.

Some examples of the method, apparatuses, and non-transitory computer-readable medium described herein may further include operations, features, means, or instructions for determining the image sharpness parameter exceeds a sharpness threshold based on the measuring, where the engagement of the brake caliper may be configured based on the image sharpness parameter exceeding the sharpness threshold. In some examples of the method, apparatuses, and non-transitory computer-readable medium described herein, configuring the engagement of the brake caliper with the lens barrel assembly may include operations, features, means, or instructions for engaging the brake caliper to fix the lens barrel assembly relative to the base mount based on the image sharpness parameter exceeding the sharpness threshold.

Some examples of the method, apparatuses, and non-transitory computer-readable medium described herein may further include operations, features, means, or instructions for determining the image sharpness parameter may be below a sharpness threshold based on the measuring, where the engagement of the brake caliper may be configured based on the image sharpness parameter being below the sharpness threshold. In some examples of the method, apparatuses, and non-transitory computer-readable medium described herein, configuring the engagement of the brake caliper with the lens barrel assembly further may include operations, features, means, or instructions for disengaging the brake caliper to release the lens barrel assembly relative to the base mount based on the image sharpness parameter being below the sharpness threshold.

In some examples of the method, apparatuses, and non-transitory computer-readable medium described herein, configuring the engagement of the brake caliper with the lens barrel assembly further may include operations, features, means, or instructions for disengaging the brake caliper to release the lens barrel assembly relative to the base mount based on a change in the measured image sharpness parameter, a change in a target scene or target object associated with capturing the image, or both.

Some examples of the method, apparatuses, and non-transitory computer-readable medium described herein may further include operations, features, means, or instructions for performing an autofocus operation with respect to a target scene or a target object, based on the vibration frequency parameter exceeding the threshold, the image sharpness parameter, or both. In some examples of the method, apparatuses, and non-transitory computer-readable medium described herein, capturing the image may include operations, features, means, or instructions for capturing the image of the target scene or the target object based on one or more focus settings associated with performing the autofocus operation. Some examples of the method, apparatuses, and non-transitory computer-readable medium described herein may further include operations, features, means, or instructions for performing the autofocus operation using the open loop voice-coil motor camera.

Some examples of the method, apparatuses, and non-transitory computer-readable medium described herein may further include operations, features, means, or instructions for determining one or more angular rotation measurements from the gyroscope sensor, where the vibration frequency parameter may be determined based on the one or more angular rotation measurements. In some examples of the method, apparatuses, and non-transitory computer-readable medium described herein, the measured image sharpness parameter may be based on a focus position of the lens barrel assembly. Some examples of the method, apparatuses, and non-transitory computer-readable medium described herein may further include operations, features, means, or instructions for performing one or more image stabilization operations based on the vibration frequency parameter. In some examples of the method, apparatuses, and non-transitory computer-readable medium described herein, the gyroscope sensor may be coupled to the base mount. In some examples of the method, apparatuses, and non-transitory computer-readable medium described herein, the brake caliper includes a programmable brake caliper.

### BRIEF DESCRIPTION OF THE DRAWINGS

FIG. 1 illustrates an example of a system for image processing that supports techniques for correcting video rolling shutter jello effect for open loop voice-coil motor cameras in accordance with aspects of the present disclosure.

FIG. 2 illustrates a diagram of a device that supports techniques for correcting video rolling shutter jello effect for open loop voice-coil motor cameras in accordance with aspects of the present disclosure.

FIGS. 3A and 3B show top and side views, respectively, of an example of a device that supports techniques for correcting video rolling shutter jello effect for open loop voice-coil motor cameras in accordance with aspects of the present disclosure.

FIG. 4 illustrates a flowchart that supports techniques for correcting video rolling shutter jello effect for open loop voice-coil motor cameras in accordance with aspects of the present disclosure.

FIGS. 5 and 6 show block diagrams of devices that support techniques for correcting video rolling shutter jello effect for open loop voice-coil motor cameras in accordance with aspects of the present disclosure.

FIG. 7 shows a block diagram of a multimedia manager that supports techniques for correcting video rolling shutter jello effect for open loop voice-coil motor cameras in accordance with aspects of the present disclosure.

FIG. 8 shows a diagram of a system including a device that supports techniques for correcting video rolling shutter jello effect for open loop voice-coil motor cameras in accordance with aspects of the present disclosure.

FIGS. 9 through 11 show flowcharts illustrating methods that support techniques for correcting video rolling shutter jello effect for open loop voice-coil motor cameras in accordance with aspects of the present disclosure.

### DETAILED DESCRIPTION

Open loop voice-coil motor camera modules may be incorporated, for example, in low-end smartphone camera modules, low-power camera modules such as internet-of-things camera modules, and so on. Open loop voice-coil motor camera modules may include a lens barrel attached to lens mount (e.g., a base mount) by a spring, and an electric current may be applied to the voice-coil motor to displace the lens barrel relative to the lens mount for focus operations. For such camera modules, incident vibrations or camera shake may result in unwanted movement of the lens barrel of the camera. For example, when a camera module is vibrating, a jello effect (e.g., a wobble effect) may arise where a captured image may appear to wobble unnaturally (e.g., images may become skewed, straight lines may become distorted, etc.). Some image stabilization processes (e.g., electronic image stabilization) may correct for the movement of the lens barrel by determining angular rotation via a mounted gyroscope sensor and performing rolling shutter correction to compensate for image warping produced by intra-frame camera motion.

However, under conditions of severe vibrations (e.g., high frequency strong vibrations), angular movement of the gyroscope sensor may not accurately represent rotation of the lens barrel (e.g., as severe vibrations may result in significant relative movement between lens barrel and gyroscope sensor). As such, image stabilization techniques (e.g., digitized image warping on captured pixel values) may be performed using inaccurate angular rotation estimations of the lens barrel, which may result in inaccurate or ineffective image stabilization (e.g., which may adversely affect focus operations, image capture, etc.).

According to the techniques described herein, a camera module (e.g., an open loop voice-coil motor camera module) may be equipped with a programmable brake caliper for improved rolling shutter correction. For example, in an open loop voice-coil motor camera module, a movable lens barrel may be positioned within a lens mount and attached to the lens mount by a spring. The brake caliper may be mounted or connected to the lens mount in between the lens barrel such that, upon engagement of the brake caliper, the lens barrel within the lens mount may be secured or fixed in position relative to the lens mount (e.g., such that engagement of the brake caliper may lock focus settings).

The camera module may engage or disengage the brake caliper based on motion detected by a gyroscope sensor coupled to the lens mount. When high frequency motion (e.g., strong vibration) is detected by a gyroscope sensor (e.g., via angular rotation measurements), the camera module may determine whether or not to engage (e.g., firmly connect) the brake caliper to the lens barrel assembly (e.g., to lock focus settings). For example, if high frequency motion is detected by the gyroscope sensor and the camera module determines image sharpness is still above a threshold (e.g., such that refocus may not be necessary), the camera module may firmly connect the brake caliper to the lens barrel assembly and lens mount. As such, when high frequency motion is detected yet the image is sharp, the brake caliper may be engaged to temporarily lock focus settings (e.g., versus otherwise refocusing the lens barrel assembly upon detection of high frequency motion). In some cases, the camera module may perform a refocus operation (e.g., if the image is blurry, if a scene change is detected, if a change in the target scene or target object is triggered, after an elapsed time period, etc.), and the camera module may release the brake caliper, allowing the lens barrel to move for refocus.

Aspects of the disclosure are initially described in the context of a multimedia system. Aspects of the disclosure are further illustrated by and described with reference to apparatus diagrams, system diagrams, and flowcharts that relate to techniques for correcting video rolling shutter jello effect for open loop voice-coil motor cameras.

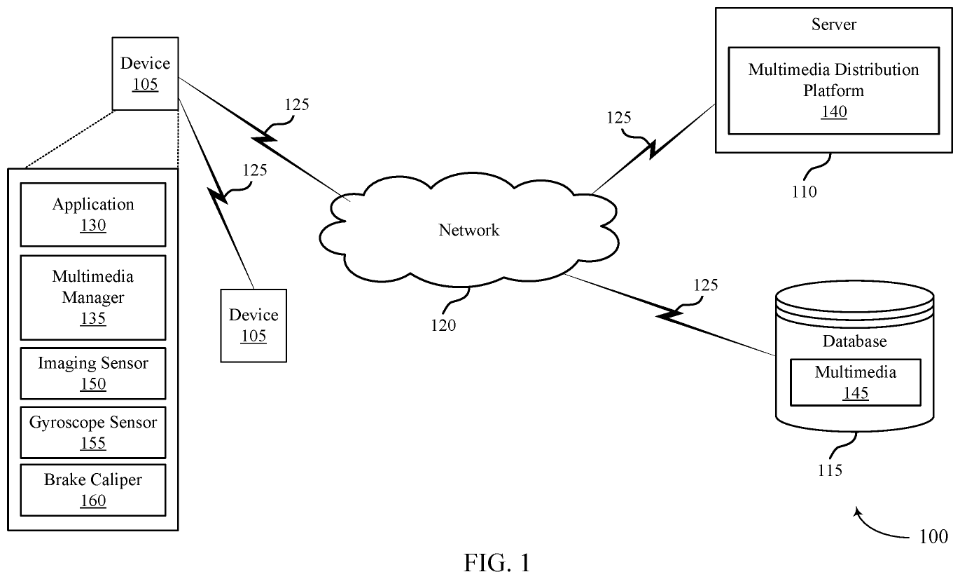

FIG. 1 illustrates an example multimedia system 100 for a device that supports techniques for correcting video rolling shutter jello effect for open loop voice-coil motor cameras in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure applies to any multimedia system architecture having one or more devices 105, servers 110, databases 115, and networks 120. In some cases, the devices 105, the server 110, and the database 115 may communicate with each other and exchange information that supports techniques for correcting video rolling shutter jello effect for open loop voice-coil motor cameras, such as multimedia packets, multimedia data, or multimedia control information, via network 120 using communications links 125. In some aspects, a portion or all of the techniques described herein supporting techniques for correcting video rolling shutter jello effect for open loop voice-coil motor cameras may be performed by the devices 105, or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some aspects, the devices 105 may also be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

The devices 105 may include an application 130, a multimedia manager 135, an imaging sensor 150, a gyroscope sensor 155, and a brake caliper 160. While, the multimedia system 100 illustrates the devices 105 including both the application 130 and the multimedia manager 135, the application 130 and the multimedia manager 135 may be an optional feature for the devices 105. In some aspects, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The imaging sensor 150 may be capable of capturing individual image frames (such as still images) and/or capturing video (such as a succession of captured image frames). In some aspects, the imaging sensor 150 may include one or more image sensors (not shown for simplicity) or pixel arrays (e.g., phase detection pixels and non-phase detection pixels) and shutters for capturing an image frame and providing the captured image frame to a controller of the device 105.

The gyroscope sensor 155 may include one or more sensors configured to measure angular velocities (e.g., angular rotation) associated with movement or motion of the device 105. In some aspects, the gyroscope sensor 155 may measure vibration levels associated with movement of the device 105. The gyroscope sensor 155 may be mounted or coupled to the device 105, for example, to a base mount of the device 105.

The brake caliper 160 may be a programmable brake caliper. In some aspects, the brake caliper 160 may be a voice-coil motor brake caliper. The brake caliper 160 may be located between a movable lens barrel included in or coupled to the device 105 and a base mount of a camera module of the device 105, aspects of which will be described herein.

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support techniques for correcting video rolling shutter jello effect for open loop voice-coil motor cameras, according to the techniques described herein.

The server 110 may be a data server, a cloud server, a server associated with an multimedia subscription provider, proxy server, web server, application server, communications server, home server, mobile server, or any combination thereof. The server 110 may in some aspects include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device 105 may support techniques for correcting video rolling shutter jello effect for open loop voice-coil motor cameras associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The wireless links (e.g., communication links 125) may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

Improved techniques for correcting video rolling shutter jello effect for open loop voice-coil motor cameras are described. A device 105 may capture an image using an open loop voice-coil motor camera including a lens barrel assembly (e.g., a lens barrel, imaging sensor 150, etc.), a base mount (e.g., a lens mount, a lens barrel mount, etc.), and a brake caliper (e.g., brake caliper 160). The base mount associated with the lens barrel assembly may include the brake caliper 160 (e.g., in between the base mount and the lens barrel assembly). The device 105 may determine a vibration frequency parameter associated with a gyroscope sensor 155 exceeds a threshold. Based on the vibration frequency parameter exceeding the threshold, the device 105 may measure an image sharpness parameter associated with the image. In some aspects, the device 105 may configure engagement of the brake caliper 160 with the lens barrel assembly (e.g., with the imaging sensor 150) based on the image sharpness parameter.

The techniques described herein may provide improvements in correcting video rolling shutter jello effect for open loop voice-coil motor cameras. Furthermore, the techniques described herein may provide benefits and enhancements to the operation of the devices 105. For example, by configuring engagement of a brake caliper with a lens barrel assembly based on a vibration frequency parameter and an image sharpness parameter, improved performance of rolling shutter correction may be achieved. The techniques described herein may also be applicable to low power, open loop voice-coil motor cameras such as internet-of-things camera modules, thus providing improved rolling shutter correction for low power camera applications.

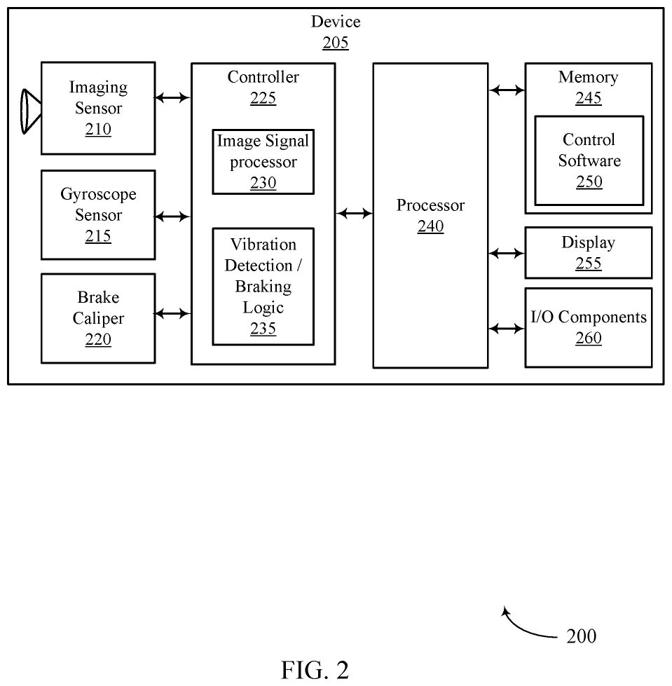

FIG. 2 illustrates a diagram 200 of a device 205 that supports techniques for correcting video rolling shutter jello effect for open loop voice-coil motor cameras in accordance with aspects of the present disclosure. In some examples, the device 205 may be an example of a device 105 or may implement aspects of techniques performed by a device 105 as described with reference to FIG. 1.

The device 205 may be any suitable device capable of capturing images or video including, for example, wired and wireless communication devices (such as camera phones, smartphones, tablets, security systems, dash cameras, laptop computers, desktop computers, automobiles, drones, aircraft, and so on), digital cameras (including still cameras, video cameras, and so on), or any other suitable device. The device 205 may include an imaging sensor 210, a gyroscope sensor 215, a brake caliper 220, a controller 225, a processor 240, a memory 245, a display 255, and a number of input/output (I/O) components 260.

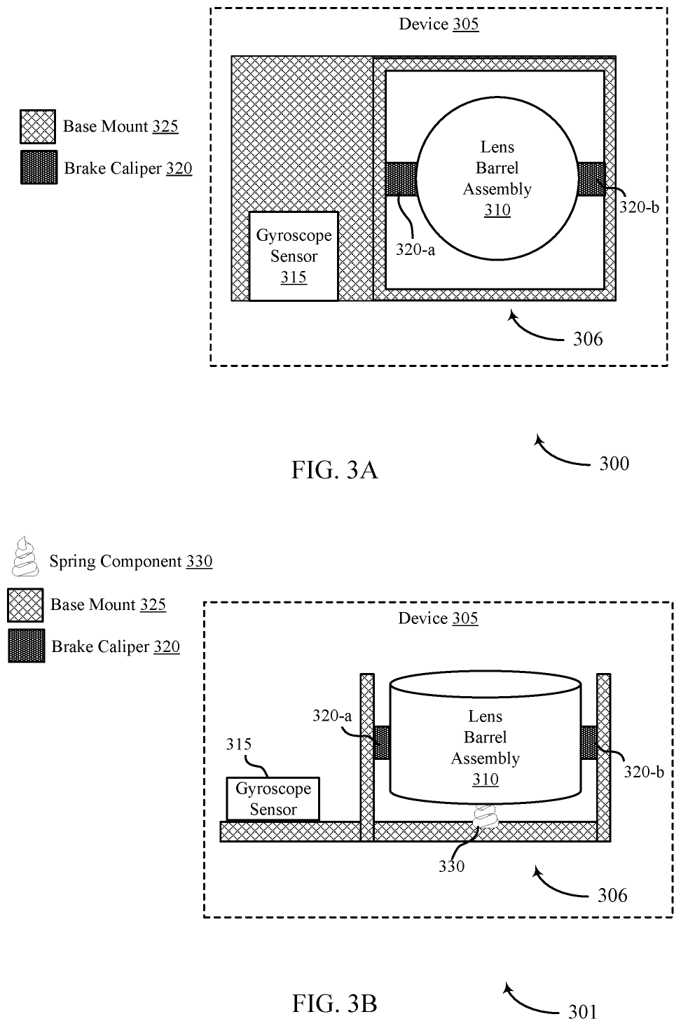

The imaging sensor 210 may detect an amount or intensity of light associated with scene or object (e.g., light emitted by or reflected from the scene or object). According to example aspects described herein, the imaging sensor 210 may detect RGB, monochrome, IR, and/or ultraviolet (UV) light values associated with a scene. The imaging sensor 210 may detect focus or sharpness values associated with the scene, a target object in the scene, or both. In some aspects, the imaging sensor 210 may capture one or more images (e.g., color or monochrome images) associated with a scene based on a combination of focus or sharpness values or settings. In some aspects, the imaging sensor 210 may be included in a camera module of the device 205, aspects of which will be described herein with respect to FIG. 3.

The imaging sensor 210 may be in electronic communication with a controller 225 and processor 240 (e.g., some image signal processor and/or image signal processing software). In some aspects, the imaging sensor 210 may be in electronic communication with the controller 225, and the controller 225 may be in electronic communication with processor 240. In some examples, the controller 225 and processor 240 may be implemented on a single substrate or system on chip (SoC), or may be separately located.

The gyroscope sensor 215 may include one or more sensors configured to measure angular velocities (e.g., angular rotation) associated with movement or motion of the device 205. In some aspects, the gyroscope sensor 215 may measure vibration levels, vibration frequency, etc. associated with movement of the device 205. The gyroscope sensor 215 may be mounted or coupled to the device 205, for example, to a base of the device 205. In some aspects, the gyroscope sensor 215 may provide detected motion (e.g., measured angular velocities, measured vibration levels, or both) to the controller 225 (e.g., to vibration detection/braking logic 235).

The brake caliper 220 may be a programmable brake caliper. In some aspects, the brake caliper 220 may be a voice-coil motor brake caliper. The brake caliper 220 may be located between a movable lens barrel included in or coupled to the device 205 and a base mount of a camera module of the device 205 (e.g., as described in more detail herein, for example, with respect to FIG. 3). The brake caliper 220 may be configured (e.g., engaged or disengaged) via commands received from the device 205 (e.g., via the controller 225). The brake caliper 220 may be engaged to firmly connect to the lens barrel and base mount of the camera module of the device 205, or released (e.g., disengaged) to allow movement of the lens barrel. In some cases, the imaging sensor 210 may include the lens barrel, the brake caliper 220, and the base mount (e.g., and the controller 225 may configure the brake caliper within the imaging sensor 210 to lock or release focus settings of the imaging sensor 210).

The controller 225 may include an image signal processor 230 and the vibration detection/braking logic 235. Image signal processor 230 may perform image signal processing operations. For example, the image signal processor 230 may perform image signal processing operations based on images captured by the imaging sensor 210. The image signal processor 230 may perform image signal processing operations based on sharpness or focus values associated with the images. The controller 225 may issue commands (e.g., engage, release) to the brake caliper 220 based on sharpness or focus values associated with images captured by the imaging sensor 210, motion detected by the gyroscope sensor 215, or both.

In some aspects, the vibration detection/braking logic 235 may include logic for detecting vibrations associated with the device 105. The vibration detection/braking logic 235 may include logic for comparing, to a frequency threshold, the frequency associated with the motion detected by the gyroscope sensor 215. In some aspects, vibration detection/braking logic 235 may include logic for issuing commands (e.g., engage, release) to the brake caliper 220 based on whether the frequency satisfies the frequency threshold (e.g., is above or below the frequency threshold). For example, in some cases, the vibration detection/braking logic 235 may process or analyze measurements from gyroscope sensor 215 to determine whether a vibration frequency parameter exceeds a threshold, to determine whether a vibration frequency parameter is below a threshold, etc. In some cases, the threshold may be preconfigured by the device 205, may be set by an application, may be set based on user preferences or user input, etc. In some examples, the threshold may be based on a latency or time associated with refocus operations. In some examples, the threshold may be based on history or patterns of vibration or angular rotation measurements measured by gyroscope sensor 215.

The vibration detection/braking logic 235 may include logic for comparing sharpness values associated with an image to a sharpness threshold. In some examples, the vibration detection/braking logic 235 may determine whether the sharpness values satisfy the sharpness threshold (e.g., are above or below the sharpness threshold). In some example aspects, the vibration detection/braking logic 235 may include logic for comparing the focus values to a focus threshold. In some aspects, the vibration detection/braking logic 235 may include logic for issuing commands (e.g., engage, release) to the brake caliper 220 based on whether the focus values satisfy the focus threshold (e.g., is above or below the focus threshold).

Alternatively or additionally, the processor 240, the controller 225, or both may perform image signal processing operations, vibration detection operations, or braking determination operations. Further, the processor 240, the controller 225, or both may perform aspects of correcting video rolling shutter jello effect for the device 205 (e.g., open loop voice-coil motor cameras).

The device 205 may be an example of aspects of device 105. For example, the imaging sensor 210, gyroscope sensor 215, and brake caliper 220 may be examples of aspects of the imaging sensor 150, gyroscope sensor 155, and brake caliper 160. The device 205 may include additional features or components not shown. For example, in some cases, a wireless interface, which may include a number of transceivers and a baseband processor, may be included for a wireless communication device. In some examples, the device 205 may include additional sensors or cameras, gyroscope sensors, or brake calipers other than the imaging sensor 210, gyroscope sensor 215, and brake caliper 220. The disclosure should not be limited to any specific examples or illustrations, including example device 205.

As discussed herein, the imaging sensor 210 may generally refer to a camera module, an image sensor, a light sensor, other sensors, or the like. For example, the imaging sensor 210 may include a lens (e.g., a lens barrel assembly), a color filter array, a pixel sensor array, and/or other hardware which may collect (e.g., focus), filter, and detect lighting information. In some cases, the imaging sensor 210 may include a base mount, programmable brake caliper 220, and gyroscope sensor 215. In some cases, a base mount (not shown) may secure or connect the imaging sensor to the device 205 (e.g., such that brake caliper 220 may be located in between the base mount and the imaging sensor 210, such that the gyroscope sensor may be attached or mounted to the base mount, etc.).

The device 205 may pass the lighting information to the controller 225 (e.g., for processing and reconstruction of the raw image data by image signal processor 230). The image signal processor 230 (e.g., one or more driver circuits for performing image processing operations) may then process the information collected by the imaging sensor 210 (e.g., to reconstruct or restore a captured image of scene and/or object in the scene). In some examples, the processed image information (e.g., determined or output from the controller 225, the image signal processor 230, and/or processor 240) may then be passed to a display 255 of the device 205. In other examples, the processed image information may be stored by device 205, passed to another device, etc. The controller 225 may include one or more driver circuits for controlling imaging sensor 210, gyroscope sensor 215, and/or brake caliper 220 (e.g., driver circuits for configuring settings of the imaging sensor 210, for configuring angular velocity or vibration measurements of gyroscope sensor 215, for configuring engagement or disengagement of brake caliper 220, etc.).

The imaging sensor 210 may be capable of capturing individual image frames (such as still images) and/or capturing video (such as a succession of captured image frames). In some aspects, the imaging sensor 210 may include one or more image sensors (not shown for simplicity) or pixel arrays (e.g., phase detection pixels and non-phase detection pixels) and shutters for capturing an image frame and providing the captured image frame to the controller 225. In some examples, a pixel sensor array may include one or more photosensitive elements for measuring such information. In some examples, the photosensitive elements may have a sensitivity to a spectrum of electromagnetic radiation (e.g., including the visible spectrum of electromagnetic radiation). For example, photosensitive elements may be tuned for sensitivity to a visible spectrum of electromagnetic radiation (e.g., by way of depth of a photodiode depletion region associated with the photosensitive element).

Memory 245 may be a non-transient or non-transitory computer readable medium storing computer executable instructions to perform all or a portion of one or more operations described in this disclosure. In some aspects, the device 205 may also include a power supply, which may be coupled to or integrated into device 205. In some aspects, the device 205 may include control software 250 including computer executable instructions for controlling the brake caliper 220 (e.g., engaging, releasing brake caliper 220). In some examples, the control software 250 may include computer executable instructions for controlling a voice-coil motor brake caliper.

In some aspects, the imaging sensor 210 may refer to a complementary metal oxide semiconductor (CMOS) image sensor, a charge-coupled device (CCD), etc. used in digital imaging applications to capture images (e.g., scenes, target objects within some scene, etc.). In some examples, the imaging sensor 210 may include an array of sensors (e.g., a pixel sensor array including phase detection pixels and non-phase detection pixels). Each sensor in the pixel sensor array may include at least one photosensitive element for outputting a signal having a magnitude proportional to the intensity of incident light or radiation contacting the photosensitive element. When exposed to incident light (e.g., visible light, invisible light) reflected by or emitted from a scene (e.g., or target object within some scene), each sensor or pixel in the pixel sensor array may output a signal having a magnitude corresponding to an intensity of light at one point in the scene (e.g., at an image capture time). The signals output from each photosensitive element may be processed (e.g., by the controller 225, the image signal processor 230, and/or processor 240) to form an image representing the captured scene or object.

Processor 240 may be one or more suitable processors capable of executing scripts or instructions of one or more software programs (such as instructions) stored within memory 245. In some aspects, processor 240 may be one or more general purpose processors that execute instructions to cause the device 205 to perform any number of functions or operations. In additional or alternative aspects, processor 240 may include integrated circuits or other hardware to perform functions or operations without the use of software. While shown to be coupled to each other via processor 240 in the example of FIG. 2, processor 240, memory 245, the controller 225, the display 255, and I/O components 260 may be coupled to one another in various arrangements. For example, processor 240, memory 245, the controller 225, display 255, and/or I/O components 260 may be coupled to each other via one or more local buses (not shown for simplicity).

The display 255 may be any suitable display or screen allowing for user interaction and/or to present items (such as captured images and video) for viewing by a user. The display 255 may include a liquid-crystal display (LCD), a light emitting diode (LED) display, an organic LED (OLED), an active-matrix OLED (AMOLED), or the like. In some cases, display 255 and the I/O components 260 may be or represent aspects of a same component (e.g., a touchscreen, a touch-sensitive display, etc.) of the device 205. The display 255 may be configured to display images captured via the imaging sensor 210. In some cases, the display 255 may be configured to display one or more regions of a captured image selected by an individual, via an input (e.g., touch, gesture). The display 255 may thus be any suitable display or screen allowing for user interaction and/or allowing for presentation of information (such as captured images and video) for viewing by a user. I/O components 260 may be or may include any suitable mechanism, interface, or device to receive input (such as commands) from the user and to provide output to the user. For example, I/O components 260 may include (but are not limited to) a graphical user interface, keyboard, mouse, microphone and speakers, and so on.

The controller 225 (e.g., a camera controller) may include an image signal processor 230, which may be one or more image signal processors to process captured image frames or video provided by the imaging sensor 210. In some example implementations, the controller 225 (such as image signal processor 230) may control operation of imaging sensor 210. For example, the controller 225 may configure the imaging sensor 210 with a focal length, capture rate, resolution, color palette (such as color versus black and white), a field of view, etc. While described herein with respect to a device including a single imaging sensor 210 (e.g., one camera), aspects of the present disclosure are applicable to any number of sensors, cameras, camera configurations, etc., and are therefore not limited to a single imaging sensor 210. In some aspects, the image signal processor 230 may execute instructions from a memory (such as instructions from memory 245 or instructions stored in a separate memory coupled to the image signal processor 230) to control operation of imaging sensor 210. In other aspects, the controller 225 may include specific hardware to control operation of imaging sensor 210. The controller 225 and/or image signal processor 230 may additionally or alternatively include a combination of specific hardware and the ability to execute software instructions. In some aspects, the controller 225 may control (e.g., rotate) a lens barrel included in or coupled to the device 205 so as to position a lens included within the lens barrel.

According to aspects described herein, the device 205 may determine angular velocities, angular rotations, vibration levels, etc. associated with movement of the device 205. In some aspects, the device 205 may determine sharpness values and focus values associated with imaging sensor 210 (e.g., associated with capturing an image of scene or target object in the scene). The device 205 may engage or release the brake caliper 220 based on the determined angular velocities, angular rotation, vibration levels, focus values, sharpness values, etc. In some aspects, the device 205 may engage or release the brake caliper 220 based on the sharpness values and focus values.

FIGS. 3A and 3B show a top view 300 and a side view 301 a device 305 that supports techniques for correcting video rolling shutter jello effect for open loop voice-coil motor cameras in accordance with aspects of the present disclosure. In some aspects, the device 305 may be an example of device 105 and/or device 205, or the device 305 may implement aspects of techniques for correcting video rolling shutter jello effect for open loop voice-coil motor cameras performed by a device 105 and/or a device 205 as described with reference to FIGS. 1 and 2.

The device 305 may include a camera module 306 and a gyroscope sensor 315 (e.g., the gyroscope sensor 315 may be included in or separate from the camera module 306). In some aspects, the camera module 306 may be an open loop voice-coil motor camera, for example, without an optical image stabilization actuator. The camera module 306 may include a lens barrel assembly 310, a brake caliper 320 (e.g., including portions 320-a and 320-b), a base mount 325, and a spring component 330.

The lens barrel assembly 310 may be attached to the base mount 325 via the spring component 330 (e.g., the lens barrel assembly 310 may be braced by the base mount 325, and attached to the bottom of the base mount via a spring component 330 such that the lens barrel assembly 320 may move up and down within the brace). When the lens barrel assembly 310 is powered off (e.g., the device 305 is powered off), the lens barrel assembly 310 and spring component 330 may rest at or return to a stop position closest to base mount 325. In some aspects, the stop position closest to the base mount 325 may correspond to an infinity focus position at which the imaging plane is focused to infinity. The device 305 may move the lens barrel assembly 310 away from or towards the base mount (e.g., rotate the lens barrel assembly 310, thereby adjusting an image focus with respect to the imaging plane), for example, by applying an electric current thereto. As the lens barrel assembly 310 moves away from the base mount 325 (e.g., via applied current) the imaging plane may be focused to some place closer and closer (e.g., until maximum lens barrel assembly 310 displacement is reached).

The gyroscope sensor 315 may be, for example, a gyro sensor capable of sensing angular rotation associated with motion of the gyroscope sensor 315. Angular rotation may include, for example, angular velocity associated with the motion of the gyroscope sensor 315. In some aspects, the device 305 may calculate or determine vibration frequency (e.g., a vibration frequency parameter) based on one or more angular rotation measurements provided by the gyroscope sensor 315.

In some aspects, the gyroscope sensor 315 may be firmly coupled to the device 305 (e.g., firmly coupled to the base mount 325). The device 305 may translate motion associated with the gyroscope sensor 315 to motion associated with the device 305 (e.g., to motion associated with the camera module 306). The gyroscope sensor 315 may transmit vibration data as electrical signals to a central processing unit (CPU) of the device 305.

In some cases, ambient vibration experienced at the device 305, such as a hand shake motion, may transfer to the camera module 306 (e.g., transfer to the lens barrel assembly 310, the base mount 325, or both). For a relatively mild vibration such as the hand shake motion, the relative movement between lens barrel assembly 310 and gyroscope sensor 315, which is firmly attached to camera base mount, may be negligible. For example, where the motion (e.g., the angular rotation) of gyroscope sensor 315 is within a threshold difference of motion (e.g., angular rotation) of the lens barrel assembly 310, the motion (e.g., the angular rotation) of the gyroscope sensor 315 may be representative of the motion (e.g., angular rotation) of the lens barrel assembly 310. Alternatively, in a relatively severe vibration, the relative movement between the lens barrel assembly 310 and gyroscope sensor 315 may exceed the threshold difference, and thus may not be accurately represent the motion (e.g., angular rotation) of the lens barrel assembly 310.

According to examples of aspects described herein, the device 305 may capture an image (e.g., of a target scene, a target object in the target scene, or both) using the camera module 306, where, for example, the camera module 306 may be an open loop voice-coil motor camera as described herein. The device 305 may determine a vibration frequency parameter associated with the gyroscope sensor 315. In some aspects, the device 305 may perform one or more image stabilization operations based on the vibration frequency parameter.

For example, the device 305 may determine whether the vibration frequency parameter satisfies or fails to satisfy a threshold (e.g., exceeds the threshold, is below the threshold). In some aspects, where the device 305 determines the vibration frequency parameter fails to satisfy the threshold (e.g., where the vibration frequency parameter is below the threshold), the device 305 may perform image stabilization using one or more techniques (e.g., electronic image stabilization). For example, the device 305 may apply one or more electronic image stabilization techniques for performing a digitized image warping on pixel values of images captured by the device 305. In some examples, the device 305 may calculate and apply an image warping matrix associated with the digitized image warping based on the angular rotation (e.g., angular rotation) of gyroscope sensor 315 as part of the electronic image stabilization.

In some example aspects, the device 305 may determine the vibration frequency parameter satisfies the threshold (e.g., determines the vibration frequency parameter is equal to or exceeds the threshold). Based on the vibration frequency parameter satisfying the threshold, the device 305 may determine or measure an image sharpness parameter associated with the image. In some examples, the device 305 may determine the image sharpness parameter based on a focus position of the lens barrel assembly 310. For example, based on the focus position, the image sharpness parameter may have a relatively higher or lower sharpness value in relation to a target scene or target object. In some aspects, the device 305 may compare the image sharpness parameter to a sharpness threshold.

Based on the image sharpness parameter and the sharpness threshold, for example, the device 305 may configure engagement of the brake caliper 320 with the lens barrel assembly 310 (e.g., engage the brake caliper 320, disengage the brake caliper 320). For example, where the device 305 determines the image sharpness parameter exceeds the sharpness threshold, the device 305 may engage the brake caliper 320. In some example aspects, engaging the brake caliper 320 may include fixing or firmly coupling the lens barrel assembly 310 relative to the base mount 325, such that motion (e.g., angular rotation) of lens barrel assembly 310 corresponds to (e.g., is fixed relative to) motion (e.g., angular rotation) of base mount 325.

Alternatively or additionally, where the device 305 determines the image sharpness parameter is below the sharpness threshold (e.g., image blurriness), the device 305 may disengage the brake caliper 320. In an example, where the device 305 determines a change in a target scene or target object associated with capturing the image, the device 305 may disengage the brake caliper 320. In some examples, the device 305 may disengage the brake caliper 320 based on time (e.g., after an elapsed time period). In some aspects, disengaging the brake caliper 320 may include releasing the lens barrel assembly 310 relative to the base mount 325.

In some additional aspects, the device 305 may configure engagement of the brake caliper 320 with the lens barrel assembly 310 (e.g., engage the brake caliper 320, disengage the brake caliper 320) based on the focus position of the lens barrel assembly 310. For example, the image sharpness parameter may be highest (e.g., have a highest sharpness value) at a focus position of the lens barrel assembly 310 which may be considered by the device 105 as a peak focus position. In some aspects, the peak focus position may correspond to a focus position determined based on a phase difference or offset between pixels (e.g., phase detection pixels) of the device 305.

The device 305 may compare the focus position of the lens barrel assembly 310 to the peak focus position and determine whether a distance between the focus position and the peak focus position satisfies a threshold (e.g., is below the threshold). Where the device 305 determines the distance satisfies the threshold, the device 305 may engage the brake caliper 320 as described herein. In some aspects, where the device 305 determines the distance fails to satisfy the threshold, the device 305 may disengage the brake caliper 320 as described herein.

In some aspects, the device 305 may perform an autofocus operation with respect to the target scene or the target object, based on the vibration frequency parameter exceeding the threshold, the image sharpness parameter, or both. For example, where the device 305 engages the brake caliper 320 (e.g., based on determining the vibration frequency parameter exceeds the threshold and determining the image sharpness parameter exceeds the sharpness threshold), the device 305 may lock one or more focus settings. For example, the device 305 may enable an autofocus lock so as to refrain from refocusing on the target scene or target object. The device 305 may capture the image of the target scene or the target object based on one or more focus settings associated with performing the autofocus operation (e.g., based on the locked focus settings).

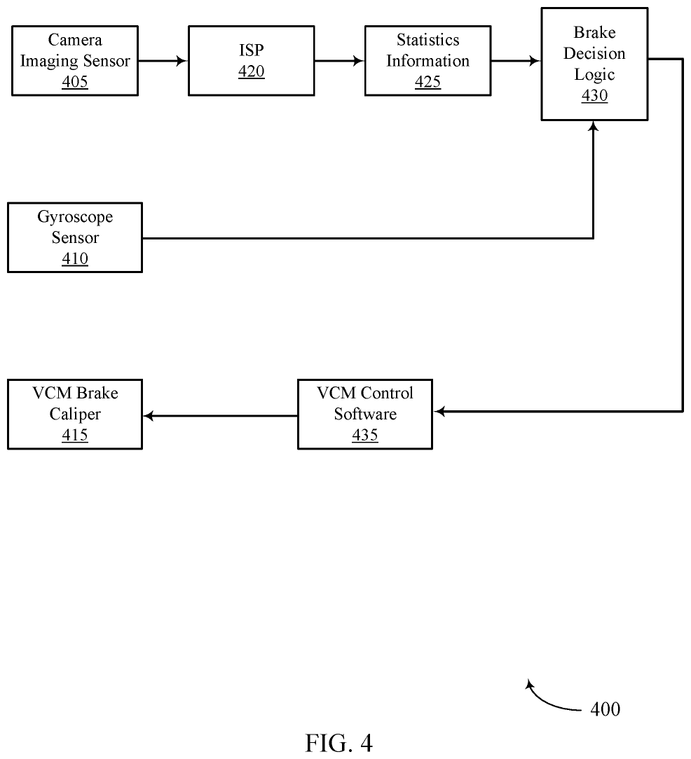

FIG. 4 illustrates a flow diagram 400 (e.g., of a device) that supports techniques for correcting video rolling shutter jello effect for open loop voice-coil motor cameras in accordance with aspects of the present disclosure. In some examples, the flow diagram 400 implement aspects of techniques performed by a device 105, a device 205, and/or a device 305 as described with reference to FIGS. 1-3.

For example, a device may include camera imaging sensor 405, gyroscope sensor 410, voice-coil motor (VCM) brake caliper 415, image signal processor (ISP) 420, brake decision logic 430, and VCM control software 435. Camera imaging sensor 405 may include one or more image sensors (not shown for simplicity) or pixel arrays (e.g., phase detection pixels and non-phase detection pixels) and shutters for capturing an image frame and providing the captured image frame to a controller (e.g., image signal processor 420) of the device. Camera imaging sensor 405 may provide capture information to image signal processor 420, and image signal processor 420 may perform image signal processing operations. For example, the image signal processor 420 may perform image signal processing operations based on images captured by the camera imaging sensor 405. for example, image signal processor 420 may determine, generate, process, etc. statistics information 425 (e.g., such as focus values, exposure grids, etc.) based on information captured by camera imaging sensor 405.

The gyroscope sensor 410 may include one or more sensors configured to measure angular velocities (e.g., angular rotation) associated with movement or motion of the device 105. In some aspects, the gyroscope sensor 410 may measure vibration levels associated with movement of the device. The gyroscope sensor 410 may be mounted or coupled to the device, for example, to a base mount of the device. The gyroscope sensor 410 may pass or signal measurements (e.g., angular rotation measurement, vibration measurements, etc.) to brake decision logic 430. Further, image signal processor 420 may pass or signal statistics information 425 (e.g., such as focus values, exposure grids, etc.) to brake decision logic 430. Brake decision logic 430 may perform high frequency vibration detection (e.g., based on measurements received from gyroscope sensor 410), analyze image sharpness or focus parameters (e.g., based on statistics information 425), etc. As such, brake decision logic 430 may determine (e.g., and configured) engagement (or disengagement) of VCM brake caliper 415 based on, for example, whether a vibration frequency parameter associated with a gyroscope sensor exceeds a threshold, based on whether an image sharpness parameter exceeds a sharpness threshold, etc. (e.g., as described in more detail herein).

Based on information processed or analyzed by brake decision logic 430, brake decision logic 430 may signal commands, instructions, information, etc. to VCM control software 435 (e.g., and VCM control software 435 may control or configure the VCM brake caliper 415 accordingly). The VCM brake caliper 415 may be a programmable brake caliper. The VCM brake caliper 415 may be located between a movable lens barrel included in or coupled to the device and a base mount of a camera module of the device (e.g., and may engage or disengage a lens barrel according to control information receive from VCM control software 435).

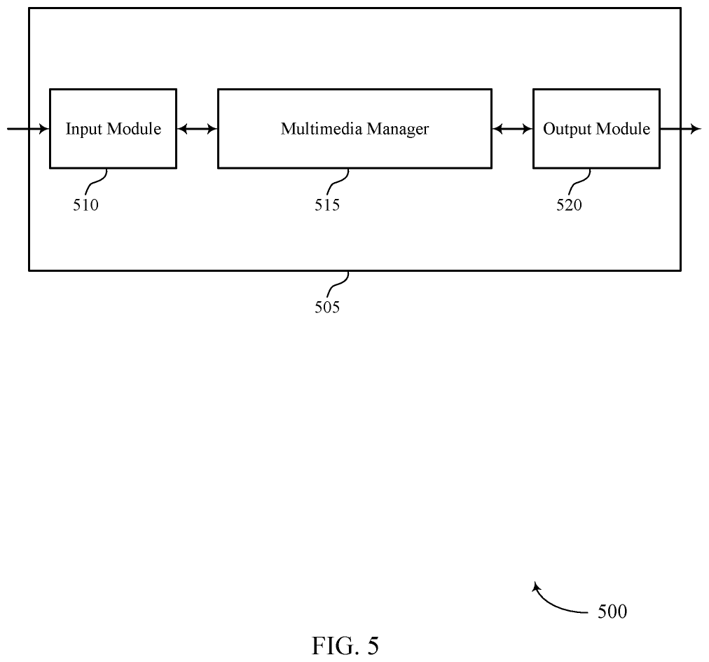

FIG. 5 shows a block diagram 500 of an device 505 that supports techniques for correcting video rolling shutter jello effect for open loop voice-coil motor cameras in accordance with aspects of the present disclosure. The device 505 may be an example of aspects of a device 105, a device 205, a device 305, or a device as described herein. The device 505 may include an input module 510, a multimedia manager 515, and an output module 520. The device 505 may also include a processor. Each of these components may be in communication with one another (e.g., via one or more buses).

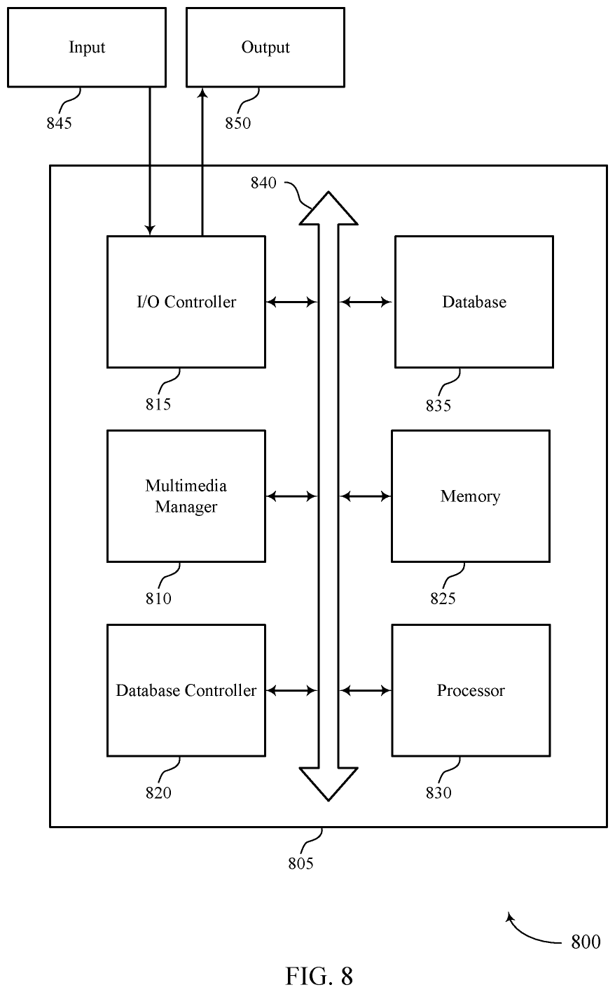

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some aspects, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the multimedia manager 515 to support techniques for correcting video rolling shutter jello effect for open loop voice-coil motor cameras. In some aspects, the input module 510 may be a component of an input/output (I/O) controller 815 as described with reference to FIG. 8.

The multimedia manager 515 may capture an image using an open loop voice-coil motor camera including a lens barrel assembly, a base mount, and a brake caliper, where the base mount associated with the lens barrel assembly includes the brake caliper, determine a vibration frequency parameter associated with a gyroscope sensor exceeds a threshold, measure an image sharpness parameter associated with the image based on the vibration frequency parameter exceeding the threshold, and configure engagement of the brake caliper with the lens barrel assembly based on the image sharpness parameter. The multimedia manager 515 may be an example of aspects of the multimedia manager 810 described herein.

The multimedia manager 515, or its sub-components, may be implemented in hardware, code (e.g., software or firmware) executed by a processor, or any combination thereof. If implemented in code executed by a processor, the functions of the multimedia manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The multimedia manager 515, or its sub-components, may be physically located at various positions, including being distributed such that portions of functions are implemented at different physical locations by one or more physical components. In some examples, the multimedia manager 515, or its sub-components, may be a separate and distinct component in accordance with various aspects of the present disclosure. In some examples, the multimedia manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The output module 520 may manage output signals for the device 505. For example, the output module 520 may receive signals from other components of the device 505, such as the multimedia manager 515, and may transmit these signals to other components or devices. In some specific examples, the output module 520 may transmit output signals for display in a user interface, for storage in a database or data store, for further processing at a server or server cluster, or for any other processes at any number of devices or systems. In some aspects, the output module 520 may be a component of an I/O controller 815 as described with reference to FIG. 8.

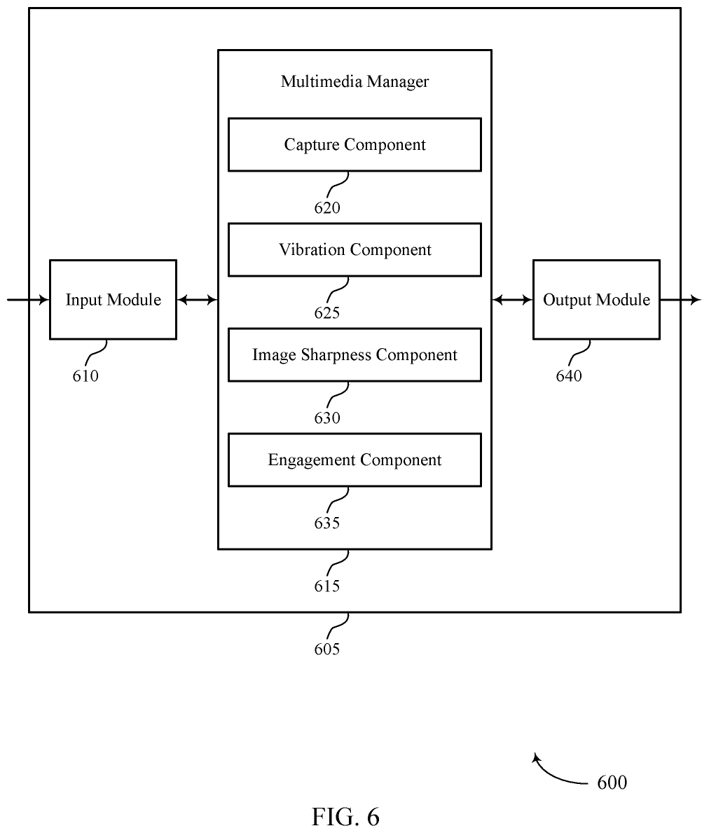

FIG. 6 shows a block diagram 600 of a device 605 that supports techniques for correcting video rolling shutter jello effect for open loop voice-coil motor cameras in accordance with aspects of the present disclosure. The device 605 may be an example of aspects of a device 105, a device 205, a device 305, a device 505, or a device as described herein. The device 605 may include an input module 610, a multimedia manager 615, and an output module 640. The device 605 may also include a processor. Each of these components may be in communication with one another (e.g., via one or more buses). In some aspects, the device 605 may be an example of a user terminal, a database server, or a system containing multiple computing devices.

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some aspects, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the multimedia manager 615 to support techniques for correcting video rolling shutter jello effect for open loop voice-coil motor cameras. In some aspects, the input module 610 may be a component of an input/output (I/O) controller 815 as described with reference to FIG. 8.

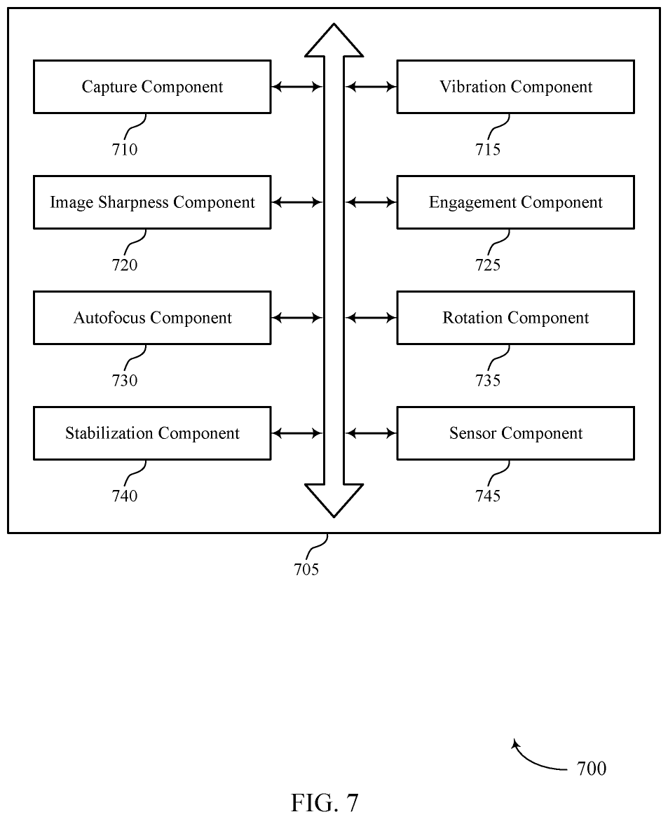

The multimedia manager 615 may be an example of aspects of the multimedia manager 515 as described herein. The multimedia manager 615 may include a capture component 620, a vibration component 625, an image sharpness component 630, and an engagement component 635. The multimedia manager 615 may be an example of aspects of the multimedia manager 705 or 810 described with reference to FIGS. 7 and 8.

The multimedia manager 615 and/or at least some of its various sub-components may be implemented in hardware, software executed by a processor, firmware, or any combination thereof. If implemented in software executed by a processor, the functions of the multimedia manager 615 and/or at least some of its various sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure. The multimedia manager 615 and/or at least some of its various sub-components may be physically located at various positions, including being distributed such that portions of functions are implemented at different physical locations by one or more physical devices. In some examples, the multimedia manager 615 and/or at least some of its various sub-components may be a separate and distinct component in accordance with various aspects of the present disclosure. In other examples, the multimedia manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The capture component 620 may capture an image using an open loop voice-coil motor camera including a lens barrel assembly, a base mount, and a brake caliper, where the base mount associated with the lens barrel assembly includes the brake caliper. The vibration component 625 may determine a vibration frequency parameter associated with a gyroscope sensor exceeds a threshold. The image sharpness component 630 may measure an image sharpness parameter associated with the image based on the vibration frequency parameter exceeding the threshold. The engagement component 635 may configure engagement of the brake caliper with the lens barrel assembly based on the image sharpness parameter.

The output module 640 may manage output signals for the device 605. For example, the output module 640 may receive signals from other components of the device 605, such as the multimedia manager 615, and may transmit these signals to other components or devices. In some specific examples, the output module 640 may transmit output signals for display in a user interface, for storage in a database or data store, for further processing at a server or server cluster, or for any other processes at any number of devices or systems. In some aspects, the output module 640 may be a component of an I/O controller 815 as described with reference to FIG. 8.

FIG. 7 shows a block diagram 700 of a multimedia manager 705 that supports techniques for correcting video rolling shutter jello effect for open loop voice-coil motor cameras in accordance with aspects of the present disclosure. The multimedia manager 705 may be an example of aspects of a multimedia manager 515, a multimedia manager 615, or a multimedia manager 810 described herein. The multimedia manager 705 may include a capture component 710, a vibration component 715, an image sharpness component 720, an engagement component 725, an autofocus component 730, a rotation component 735, a stabilization component 740, and a sensor component 745. Each of these modules may communicate, directly or indirectly, with one another (e.g., via one or more buses).

The capture component 710 may capture an image using an open loop voice-coil motor camera including a lens barrel assembly, a base mount, and a brake caliper, where the base mount associated with the lens barrel assembly includes the brake caliper. In some examples, the capture component 710 may capture the image of the target scene or the target object based on one or more focus settings associated with performing the autofocus operation. The vibration component 715 may determine a vibration frequency parameter associated with a gyroscope sensor exceeds a threshold.

The image sharpness component 720 may measure an image sharpness parameter associated with the image based on the vibration frequency parameter exceeding the threshold. In some examples, the image sharpness component 720 may determine the image sharpness parameter exceeds a sharpness threshold based on the measuring, where the engagement of the brake caliper is configured based on the image sharpness parameter exceeding the sharpness threshold. In some examples, the image sharpness component 720 may determine the image sharpness parameter is below a sharpness threshold based on the measuring, where the engagement of the brake caliper is configured based on the image sharpness parameter being below the sharpness threshold. In some aspects, the measured image sharpness parameter is based on a focus position of the lens barrel assembly.

The engagement component 725 may configure engagement of the brake caliper with the lens barrel assembly based on the image sharpness parameter. In some examples, the engagement component 725 may engage the brake caliper to fix the lens barrel assembly relative to the base mount based on the image sharpness parameter exceeding the sharpness threshold. In some examples, the engagement component 725 may disengage the brake caliper to release the lens barrel assembly relative to the base mount based on the image sharpness parameter being below the sharpness threshold. In some examples, the engagement component 725 may disengage the brake caliper to release the lens barrel assembly relative to the base mount based on a change in the measured image sharpness parameter, a change in a target scene or target object associated with capturing the image, or both. In some aspects, the brake caliper includes a programmable brake caliper.

The autofocus component 730 may perform an autofocus operation with respect to a target scene or a target object, based on the vibration frequency parameter exceeding the threshold, the image sharpness parameter, or both. In some examples, the autofocus component 730 may perform the autofocus operation using the open loop voice-coil motor camera. The rotation component 735 may determine one or more angular rotation measurements from the gyroscope sensor, where the vibration frequency parameter is determined based on the one or more angular rotation measurements. The stabilization component 740 may perform one or more image stabilization operations based on the vibration frequency parameter. The sensor component 745 may include a gyroscope sensor. In some aspects, the gyroscope sensor is coupled to the base mount.

FIG. 8 shows a diagram of a system 800 including a device 805 that supports techniques for correcting video rolling shutter jello effect for open loop voice-coil motor cameras in accordance with aspects of the present disclosure. The device 805 may be an example of or include the components of a device 105, a device 205, a device 305, a device 505, a device 605, or a device as described herein. The device 805 may include components for bi-directional data communications including components for transmitting and receiving communications, including a multimedia manager 810, an I/O controller 815, a database controller 820, memory 825, a processor 830, and a database 835. These components may be in electronic communication via one or more buses (e.g., bus 840).

The multimedia manager 810 may be an example of a multimedia manager 615 or 705 as described herein. For example, the multimedia manager 810 may perform any of the methods or processes described herein with reference to FIGS. 6 and 7. In some aspects, the multimedia manager 810 may be implemented in hardware, software executed by a processor, firmware, or any combination thereof.

The I/O controller 815 may manage input signals 845 (e.g., captured image information, gyroscope measurements, etc.) and output signals 850 for the device 805. The I/O controller 815 may also manage peripherals not integrated into the device 805. In some aspects, the I/O controller 815 may represent a physical connection or port to an external peripheral. In some aspects, the I/O controller 815 may utilize an operating system such as iOS®, ANDROID®, MS-DOS®, MS-WINDOWS®, OS/2®, UNIX®, LINUX®, or another known operating system. In other aspects, the I/O controller 815 may represent or interact with a modem, a keyboard, a mouse, a touchscreen, or a similar device. In some aspects, the I/O controller 815 may be implemented as part of a processor. In some aspects, a user may interact with the device 805 via the I/O controller 815 or via hardware components controlled by the I/O controller 815.

The database controller 820 may manage data storage and processing in a database 835. In some aspects, a user may interact with the database controller 820. In other aspects, the database controller 820 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor to perform various functions described herein. In some aspects, the memory 825 may contain, among other things, a basic input/output system (BIOS) which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some aspects, the processor 830 may be configured to operate a memory array using a memory controller. In other aspects, a memory controller may be integrated into the processor 830. The processor 830 may be configured to execute computer-readable instructions stored in a memory 825 to perform various functions (e.g., functions or tasks supporting techniques for correcting video rolling shutter jello effect for open loop voice-coil motor cameras).

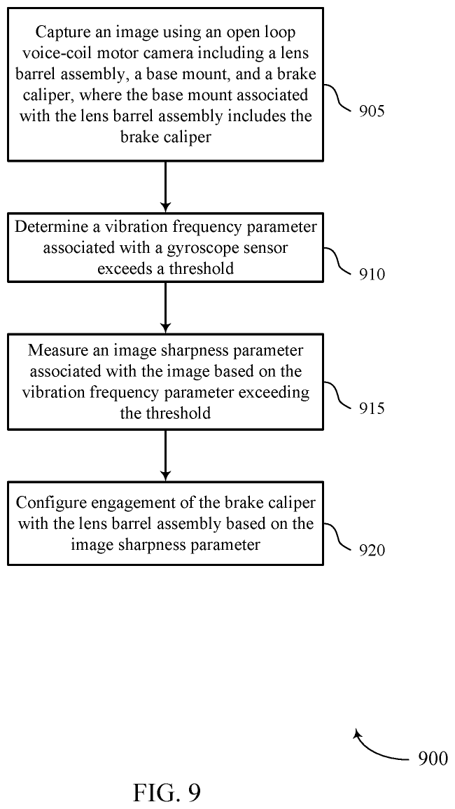

FIG. 9 shows a flowchart illustrating a method 900 that supports techniques for correcting video rolling shutter jello effect for open loop voice-coil motor cameras in accordance with aspects of the present disclosure. The operations of method 900 may be implemented by a device or its components as described herein. For example, the operations of method 900 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 905, the device may capture an image using an open loop voice-coil motor camera including a lens barrel assembly, a base mount, and a brake caliper, where the base mount associated with the lens barrel assembly includes the brake caliper. The operations of 905 may be performed according to the methods described herein. In some examples, aspects of the operations of 905 may be performed by a capture component as described with reference to FIGS. 5 through 8.

At 910, the device may determine a vibration frequency parameter associated with a gyroscope sensor exceeds a threshold. The operations of 910 may be performed according to the methods described herein. In some examples, aspects of the operations of 910 may be performed by a vibration component as described with reference to FIGS. 5 through 8.

At 915, the device may measure an image sharpness parameter associated with the image based on the vibration frequency parameter exceeding the threshold. The operations of 915 may be performed according to the methods described herein. In some examples, aspects of the operations of 915 may be performed by an image sharpness component as described with reference to FIGS. 5 through 8.

At 920, the device may configure engagement of the brake caliper with the lens barrel assembly based on the image sharpness parameter. The operations of 920 may be performed according to the methods described herein. In some examples, aspects of the operations of 920 may be performed by an engagement component as described with reference to FIGS. 5 through 8.

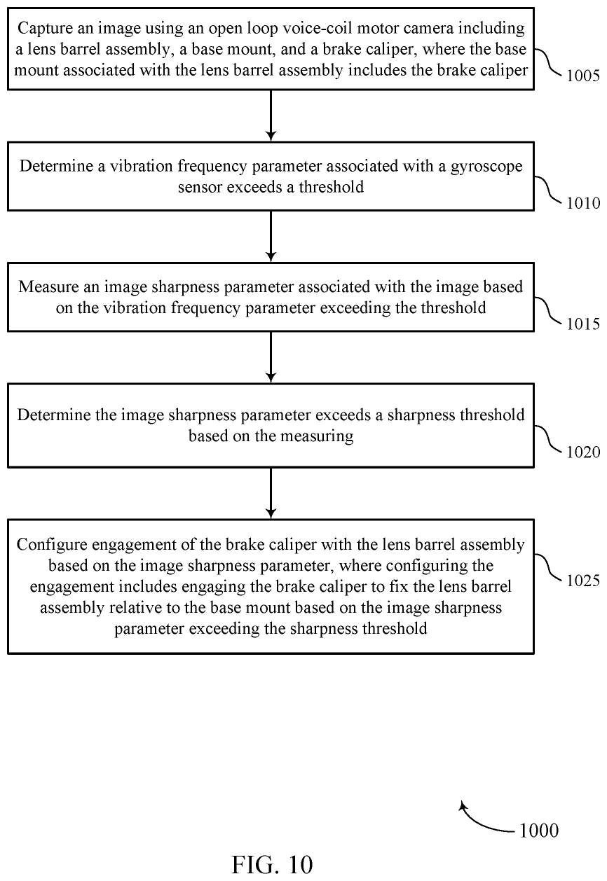

FIG. 10 shows a flowchart illustrating a method 1000 that supports techniques for correcting video rolling shutter jello effect for open loop voice-coil motor cameras in accordance with aspects of the present disclosure. The operations of method 1000 may be implemented by a device or its components as described herein. For example, the operations of method 1000 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1005, the device may capture an image using an open loop voice-coil motor camera including a lens barrel assembly, a base mount, and a brake caliper, where the base mount associated with the lens barrel assembly includes the brake caliper. The operations of 1005 may be performed according to the methods described herein. In some examples, aspects of the operations of 1005 may be performed by a capture component as described with reference to FIGS. 5 through 8.

At 1010, the device may determine a vibration frequency parameter associated with a gyroscope sensor exceeds a threshold. The operations of 1010 may be performed according to the methods described herein. In some examples, aspects of the operations of 1010 may be performed by a vibration component as described with reference to FIGS. 5 through 8.

At 1015, the device may measure an image sharpness parameter associated with the image based on the vibration frequency parameter exceeding the threshold. The operations of 1015 may be performed according to the methods described herein. In some examples, aspects of the operations of 1015 may be performed by an image sharpness component as described with reference to FIGS. 5 through 8.

At 1020, the device may determine the image sharpness parameter exceeds a sharpness threshold based on the measuring (e.g., based on comparing the measured image sharpness parameter to the sharpness threshold). The operations of 1020 may be performed according to the methods described herein. In some examples, aspects of the operations of 1020 may be performed by an image sharpness component as described with reference to FIGS. 5 through 8.

At 1025, the device may configure engagement of the brake caliper with the lens barrel assembly based on the image sharpness parameter exceeding the image sharpness threshold. In configuring engagement of the brake caliper, the device may engage the brake caliper to fix the lens barrel assembly relative to the base mount based on the image sharpness parameter exceeding the sharpness threshold. The operations of 1025 may be performed according to the methods described herein. In some examples, aspects of the operations of 1025 may be performed by an engagement component as described with reference to FIGS. 5 through 8.

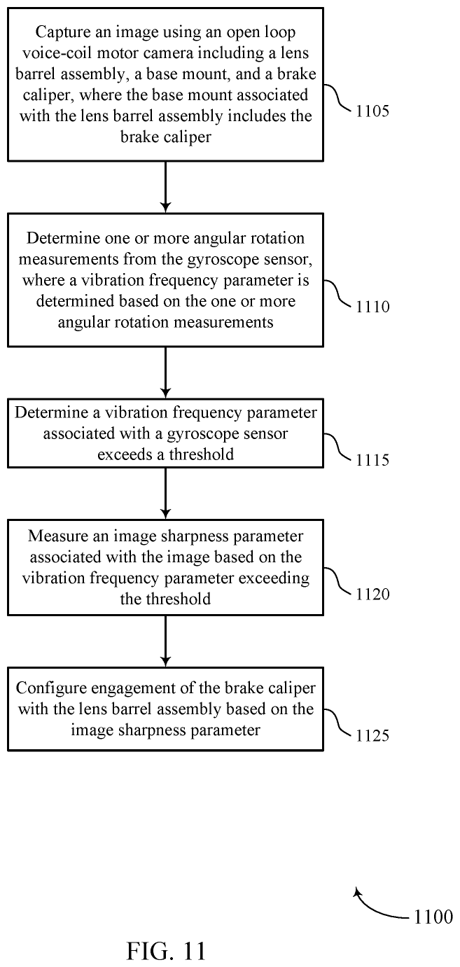

FIG. 11 shows a flowchart illustrating a method 1100 that supports techniques for correcting video rolling shutter jello effect for open loop voice-coil motor cameras in accordance with aspects of the present disclosure. The operations of method 1100 may be implemented by a device or its components as described herein. For example, the operations of method 1100 may be performed by a multimedia manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1105, the device may capture an image using an open loop voice-coil motor camera including a lens barrel assembly, a base mount, and a brake caliper, where the base mount associated with the lens barrel assembly includes the brake caliper. The operations of 1105 may be performed according to the methods described herein. In some examples, aspects of the operations of 1105 may be performed by a capture component as described with reference to FIGS. 5 through 8.

At 1110, the device may determine one or more angular rotation measurements from the gyroscope sensor, where a vibration frequency parameter is determined based on the one or more angular rotation measurements. The operations of 1110 may be performed according to the methods described herein. In some examples, aspects of the operations of 1110 may be performed by a rotation component as described with reference to FIGS. 5 through 8.

At 1115, the device may determine the vibration frequency parameter associated with a gyroscope sensor exceeds a threshold. The operations of 1115 may be performed according to the methods described herein. In some examples, aspects of the operations of 1115 may be performed by a vibration component as described with reference to FIGS. 5 through 8.

At 1120, the device may measure an image sharpness parameter associated with the image based on the vibration frequency parameter exceeding the threshold. The operations of 1120 may be performed according to the methods described herein. In some examples, aspects of the operations of 1120 may be performed by an image sharpness component as described with reference to FIGS. 5 through 8.

At 1125, the device may configure engagement of the brake caliper with the lens barrel assembly based on the image sharpness parameter. The operations of 1125 may be performed according to the methods described herein. In some examples, aspects of the operations of 1125 may be performed by an engagement component as described with reference to FIGS. 5 through 8.

It should be noted that the methods described herein describe possible implementations, and that the operations and the steps may be rearranged or otherwise modified and that other implementations are possible. Furthermore, aspects from two or more of the methods may be combined. The described operations performed by a device may be performed in a different order than the order described, or the operations may be performed in different orders or at different times. Certain operations may also be left excluded or skipped, or other operations may be added. For example, a device may implement aspects of the techniques described herein as one or more stages (e.g., such as an image truncation stage, a neural network processing stage, a continuality analysis stage, an edge detection filter stage, etc.), where stages may be implemented separately, may be implemented together to confirm decision making or provide more robustness to split-screen detection, and may be implemented in any combination and order based on system needs, the device capability, etc.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, the controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image capturing at a device, comprising:
capturing an image using an open loop voice-coil motor camera comprising a lens barrel assembly, a base mount, and a brake caliper, wherein the base mount associated with the lens barrel assembly comprises the brake caliper;
determining a vibration frequency parameter associated with a gyroscope sensor exceeds a threshold;
measuring an image sharpness parameter associated with the image based at least in part on the vibration frequency parameter exceeding the threshold; and
configuring engagement of the brake caliper with the lens barrel assembly based at least in part on the image sharpness parameter.

2. The method of claim 1, further comprising:
determining the image sharpness parameter exceeds a sharpness threshold based at least in part on the measuring, wherein the engagement of the brake caliper is configured based at least in part on the image sharpness parameter exceeding the sharpness threshold.

3. The method of claim 2, wherein configuring the engagement of the brake caliper with the lens barrel assembly comprises:
engaging the brake caliper to fix the lens barrel assembly relative to the base mount based at least in part on the image sharpness parameter exceeding the sharpness threshold.

4. The method of claim 1, further comprising:
determining the image sharpness parameter is below a sharpness threshold based at least in part on the measuring, wherein the engagement of the brake caliper is configured based at least in part on the image sharpness parameter being below the sharpness threshold.

5. The method of claim 4, wherein configuring the engagement of the brake caliper with the lens barrel assembly further comprises:
disengaging the brake caliper to release the lens barrel assembly relative to the base mount based at least in part on the image sharpness parameter being below the sharpness threshold.

6. The method of claim 1, wherein configuring the engagement of the brake caliper with the lens barrel assembly further comprises:
disengaging the brake caliper to release the lens barrel assembly relative to the base mount based at least in part on a change in the measured image sharpness parameter, a change in a target scene or target object associated with capturing the image, or both.

7. The method of claim 1, further comprising:
performing an autofocus operation with respect to a target scene or a target object, based at least in part on the vibration frequency parameter exceeding the threshold, the image sharpness parameter, or both.

8. The method of claim 7, wherein capturing the image comprises:
capturing the image of the target scene or the target object based at least in part on one or more focus settings associated with performing the autofocus operation.

9. The method of claim 7, further comprising:
performing the autofocus operation using the open loop voice-coil motor camera.

10. The method of claim 1, further comprising:
determining one or more angular rotation measurements from the gyroscope sensor, wherein the vibration frequency parameter is determined based at least in part on the one or more angular rotation measurements.

11. The method of claim 1, wherein the measured image sharpness parameter is based at least in part on a focus position of the lens barrel assembly.

12. The method of claim 1, further comprising:
performing one or more image stabilization operations based at least in part on the vibration frequency parameter.

13. The method of claim 1, wherein the gyroscope sensor is coupled to the base mount.

14. The method of claim 1, wherein the brake caliper comprises a programmable brake caliper.

15. An apparatus for image capturing at a device, comprising:
a lens barrel;
a base mount bracing the lens barrel;
a programmable brake caliper coupled with the base mount;
a gyroscope sensor;
a processor;
memory coupled with the processor; and
instructions stored in the memory and executable by the processor to cause the apparatus to:
determine a vibration frequency parameter associated with the gyroscope sensor exceeds a threshold;
measure an image sharpness parameter associated with an image based at least in part on the vibration frequency parameter exceeding the threshold; and
configure engagement of the programmable brake caliper with the lens barrel assembly based at least in part on the image sharpness parameter.

16. The apparatus of claim 15, wherein the instructions are further executable by the processor to cause the apparatus to:
determine the image sharpness parameter exceeds a sharpness threshold based at least in part on the measuring, wherein the engagement of the programmable brake caliper is configured based at least in part on the image sharpness parameter exceeding the sharpness threshold.

17. The apparatus of claim 16, wherein the instructions to configure the engagement of the brake caliper with the lens barrel assembly are executable by the processor to cause the apparatus to:
engage the programmable brake caliper to fix the lens barrel assembly relative to the base mount based at least in part on the image sharpness parameter exceeding the sharpness threshold.

18. The apparatus of claim 15, wherein the instructions are further executable by the processor to cause the apparatus to:
determine the image sharpness parameter is below a sharpness threshold based at least in part on the measuring, wherein the engagement of the programmable brake caliper is configured based at least in part on the image sharpness parameter being below the sharpness threshold.

19. The apparatus of claim 18, wherein the instructions to configure the engagement of the programmable brake caliper with the lens barrel assembly further are executable by the processor to cause the apparatus to:
disengage the programmable brake caliper to release the lens barrel assembly relative to the base mount based at least in part on the image sharpness parameter being below the sharpness threshold.

20. An apparatus for image capturing at a device, comprising:
means for capturing an image using an open loop voice-coil motor camera comprising a lens barrel assembly, a base mount, and a brake caliper, wherein the base mount associated with the lens barrel assembly comprises the brake caliper;
means for determining a vibration frequency parameter associated with a gyroscope sensor exceeds a threshold;
means for measuring an image sharpness parameter associated with the image based at least in part on the vibration frequency parameter exceeding the threshold; and
means for configuring engagement of the brake caliper with the lens barrel assembly based at least in part on the image sharpness parameter.
